(19) United States
(12) Patent Application Publication
(10) Pub. No.: US 2020/0410429 A1
(43) Pub. Date: Dec. 31, 2020

(54) SYSTEM AND METHOD FOR DEACTIVATING A DRIVER USING A MOBILITY-AS-A-SERVICE SYSTEM

(71) Applicant: Toyota Motor Engineering & Manufacturing North America,Inc., Plano, TX (US)

(72) Inventor: Ryan M. Wiesenberg, Ann Arbor, MI (US)

(21) Appl. No.: 16/452,742

(22) Filed: Jun. 26, 2019

(51) Int. Cl. G06Q 10/06; H04W 4/44; H04W 4/20

(52) U.S. Cl. CPC G06Q 10/063114; H04W 4/20; H04W 4/44

(57) ABSTRACT

A Mobility-as-a-Service system and related method for deactivating at least one driver of a vehicle includes one or more processors and a memory device in communication with the one or more processors. The memory device stores a driver list generating module, a driver state module, and a deactivation module. The driver list generating module causes the one or more processors to generate a list that includes an identity and an activity state of the at least one driver. The driver state module causes the one or more processors to determine that the at least one driver indicated as active on the list is inactive based on an activity factor. The deactivation module causes the one or more processors to deactivate the at least one driver determined to be inactive.

### TECHNICAL FIELD

The subject matter described herein relates, in general, to a system and method for deactivating at least one driver of a vehicle for a Mobility-as-a-Service (“MaaS”) provider.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

Some current MaaS systems utilized by MaaS providers may require drivers for the MaaS providers to indicate whether they are active or inactive. When active, the driver is responding to requests from the MaaS provider to pick up passengers. When inactive, the driver is not responding to requests from the MaaS provider to pick up passengers. A driver for a MaaS provider may utilize an application on a device, such as a mobile phone, that has a user interface that allows the driver for the MaaS provider to indicate whether they are active or inactive.

As such, the onus is on the driver to indicate whether they are active or inactive. It has been observed that some drivers routinely forget to mark themselves as either active or inactive at appropriate times. In some cases, passengers are assigned drivers that, while they are marked as active, are actually inactive. Situations such as these create an unpleasant experience for the passengers, as they may wait an inordinate amount of time for the MaaS provider to reassign a driver to them.

In addition to being an unpleasant experience for passengers, the driver for the MaaS system may be “downgraded” for failing to pick up a passenger when they are indicated to be active. This may ultimately result in the driver being suspended or terminated by the MaaS provider.

### SUMMARY

This section generally summarizes the disclosure and is not a comprehensive explanation of its full scope or all its features.

In one embodiment, a MaaS system for deactivating at least one driver of a vehicle includes one or more processors and a memory device in communication with the one or more processors. The memory device stores a driver list generating module, a driver state module, and a deactivation module. The driver list generating module causes the one or more processors to generate a list that includes an identity and an activity state of the at least one driver. The driver state module causes the one or more processors to determine that the at least one driver indicated as active on the list is inactive based on an activity factor. The deactivation module causes the one or more processors to deactivate the at least one driver determined to be inactive.

In another embodiment, a method for deactivating at least one driver of a vehicle of a MaaS provider includes the steps of generating by a MaaS system a list that includes an identity and an activity state of the at least one driver, determining, by the MaaS system, that the at least one driver indicated as active on the list is inactive based on an activity factor, and deactivating, by the MaaS system, the at least one driver determined to be inactive by changing the activity state of the at least one driver to inactive.

In yet another embodiment, a non-transitory computer-readable medium for deactivating at least one driver of a vehicle, using a MaaS system, may include instructions that when executed by one or more processors cause the one or more processors to generate a list that includes an identity and an activity state of the at least one driver, determine that the at least one driver indicated as active on the list is inactive based on an activity factor, and deactivate the at least one driver determined to be inactive by changing the activity state of the at least one driver to inactive.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a block diagram of a general overview of a MaaS system for deactivating at least one driver of a vehicle;

FIG. 2 is a more detailed block diagram of a MaaS system for deactivating at least one driver of a vehicle; and

FIG. 3 illustrates a method for deactivating at least one driver of a vehicle.

### DETAILED DESCRIPTION

A Mobility-as-a-Service system and related method for can determine situations where the driver is currently listed as being active but should be listed as inactive based on an activity factor. When determining that the driver should be listed as inactive, the system and related method can deactivate the driver. By so doing, the system and method remove the inactive driver from the pool of available drivers, thus avoiding situations where the MaaS system assigns a driver, who is actually inactive but listed as active, to pick up a passenger.

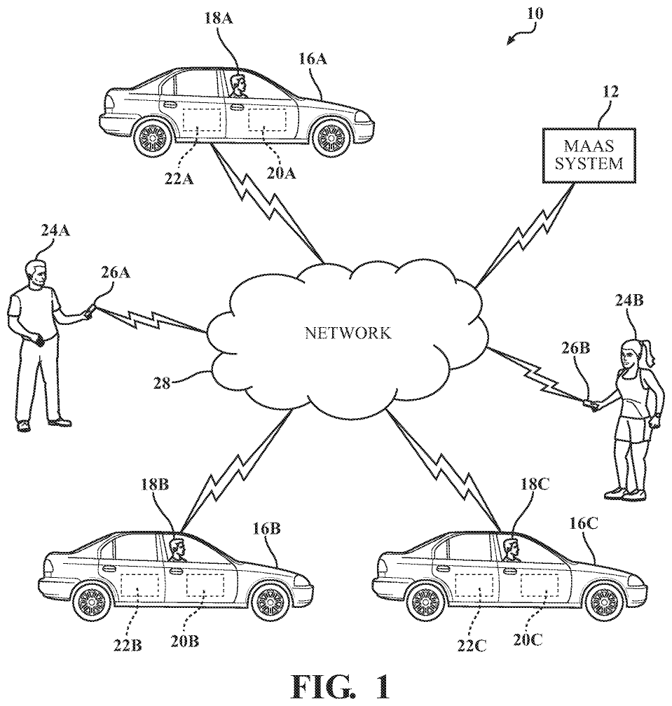

Referring to FIG. 1, a system 10 incorporating the MaaS system 12 is shown. The system 10 is essentially an example of one implementation of the MaaS system 12 for deactivating a driver listed as active. In this example, the system 10 includes vehicles 16A, 16B, and 16C that are operated by drivers 18A, 18B, and 18C, respectively.

It should be understood that the vehicles 16A, 16B, and 16C may be any one of a number of different types of vehicles capable of transporting persons or items from one location to another. In the example shown in FIG. 1, the vehicles 16A, 16B, and 16C are in the form of an automobile. However, the vehicles 16A, 16B, and 16C may take any one of a number of different forms, such as a truck, heavy-duty truck, tractor trailer, tractor, mining vehicle, military vehicle, and the like. In addition, the vehicles 16A, 16B, and 16C may not be limited to ground-based vehicles but could also include aircraft and seagoing vessels as well. Also, it should be unstood that system 10 may have any number of vehicles, drivers, or passengers and is not limited to what is shown in the figures.

The drivers 18A, 18B, and 18C, may have devices 20A, 20B, and 20C, respectively. The devices 20A, 20B, and 20C, may be in the form of a mobile device, such as a mobile phone, that has an application installed that allows the drivers 18A, 18B, and 18C, via the devices 20A, 20B, and 20C, respectively, to communicate with the MaaS system 12. This communication may be performed wirelessly through distributed network 28, such as the Internet. As will be explained later in this disclosure, the devices 20A, 20B, and 20C may take any one of a number of different forms and may not be limited to mobile devices.

The vehicles 16A, 16B, and 16C may also include vehicle data collection devices 22A, 22B, and 22C, respectively. The vehicle data collection devices 22A, 22B, and 22C, as will be described later in this disclosure, may be able to collect information regarding the activities of the vehicles 16A, 16B, and 16C and transmit the collected activity to the MaaS system 12 via the distributed network 28.

Also shown in this example are passengers 24A and 24B. The passengers 24A and 24B are persons that may be seeking transportation provided by one of the drivers 18A, 18B, and/or 18C from a current location to a destination location. The passengers 24A and 24B may be in possession of devices 26A and 26B, respectively. The devices 26A and/or 26B may be in the form of a mobile device, such as a mobile phone, that has an application installed that allows for the passengers 24A and 24B, via the devices 26A and 26B, respectively, to communicate with the MaaS system 12 via the network 28. However, it should be understood the devices 26A and 26B may take any one of several different forms and are not necessarily limited to mobile devices. For example, the devices 26A and 26B may be tablet computers, personal computers, or any other type of electronic device capable of communicating to the MaaS system 12.

In order for a passenger, such as passenger 24A to receive transportation from one of the drivers 18A, 18B, or 18C, the passenger 24A utilizes the device 26A to request a ride from a current location to a destination location. The passenger 24A may utilize an application that is installed in the device 26A that has been designed to allow communication with the MaaS system 12 via the device 26A. When requesting transportation, the passenger 24A requests transportation via the application on the device 26A, which sends one or more signals to the MaaS system 12 indicating that the passenger 24A desires transportation.

In addition to the request for transportation, the passenger 24A, via the device 26A, may also be able to provide additional information such as the number of passengers involved, the type of vehicle the passenger 24A would like to be transported in, their present location, the destination location that they would like to travel to, billing information, special requirements or accommodations, etc. The origin location may be provided by utilizing the location-based services of the device 26A, which may be equipped with a Global Navigation Satellite System (“GNSS”) system which can provide coordinates representing the origin location of the passenger 24A to the MaaS system 12.

Upon receiving the transportation request and/or other information from the passenger 24A, the MaaS system 12 assigns at least one of the drivers 18A, 18B, or 18C to pick up the passenger 24 a at the origin location and transport the passenger 24 a to a destination location. In order to determine which one of the drivers 18A, 18B, and/or 18C to assign to pick up the passenger 24A, the MaaS system 12 may utilize a number of different factors. For example, the MaaS system 12 may determine which of the drivers 18A, 18B, and/or 18C is closest, either by distance or time, to the origin location of the passenger 24A and assign the closest driver to pick up the passenger 24A.

However, while a number different methodologies can be utilized to determine which of the 18A, 18B, and/or 18C should be assigned to pick up the passenger 24A, such is closest by distance or time, the MaaS system 12 may first determine which drivers 18A, 18B, and/or 18C are active. In one example, an active driver is determined to be a driver that is responsive to requests from the MaaS system 12 to pick up a passenger, such as passenger 24A. Conversely, a driver is determined to be inactive when the driver is not responsive to requests from the MaaS system 12 to pick up a passenger, such as passenger 24A.

One way for the drivers 18A, 18B, and/or 18C to indicate to the MaaS system 12 that they are active is to provide a status indication that they are active and/or desire to receive ride requests from the MaaS system 12. This status indication may be transmitted to the MaaS system 12 by the devices 20A, 20B, and/or 20C. Likewise, a status indication that the drivers 18A, 18B, and/or 18C are inactive may also be transmitted to the MaaS system 12 by the devices 20A, 20B, and/or 20C. It should be understood that the terms “active” and “inactive” are descriptive terms and could be replaced with other terms such as “online” and “off-line” and the like.

Nevertheless, one or more of the drivers 18A, 18B, and/or 18C may fail to update their status indication from active to inactive when one or more of the drivers 18A, 18B, and/or 18C no longer wish to receive ride requests from the MaaS system 12. When such a situation arises, the MaaS system 12 continues to send ride requests to the one or more of the drivers 18A, 18B, and/or 18C that longer wish to receive ride requests. This will result in a significant delay for the passenger, as the driver assigned to pick up the passenger may not pick up the passenger or may be delayed. This causes distress to the passenger and may require the passenger to request yet another ride from the MaaS system 12 that hopefully results in the assignment of a truly active driver to pick up the passenger. As will be described in more detail in this disclosure, the MaaS system 12 and related methods overcome this problem by automatically deactivating the driver when the driver is no longer active.

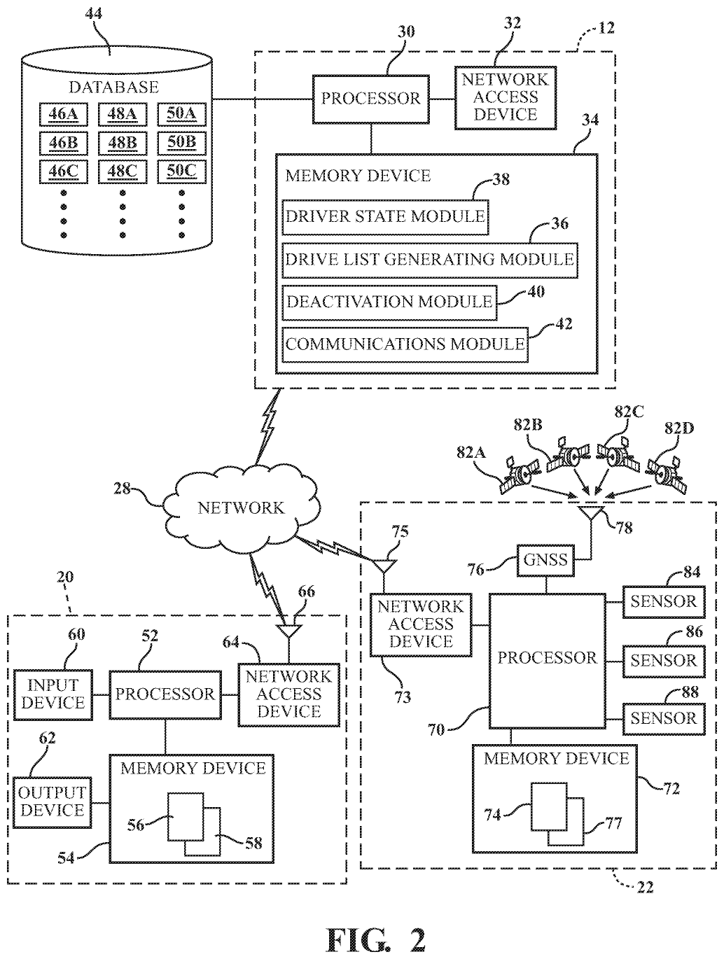

Referring to FIG. 2, a more detailed illustration of the MaaS system 12, device 20, and the vehicle data collection device 22 are shown. The device 20 of FIG. 2 may be similar to the devices 20A, 20B and/or 20C of FIG. 1. Similarly, the vehicle data collection device 22 may be similar to the vehicle data collection devices 22A, 22B, and 22C of FIG. 1.

The MaaS system 12 may include one or more processors 30, a network access device 32 in communication with the one or more processors 30 and a memory device 34 in communication with the one or more processors 30. The network access device 32 may be an electronic device, such as a circuit, that connects the one or more processors 30 a to network 28, such as the Internet. The network access device 32 may include any equipment required to male a connection to a wide area network from a local area network. As such, the network access device 32 acts as a conduit that allows for the communication of the one or more processors 30 to communicate with a number of different devices, such as the device 20 and/or the vehicle data collection device 22.

The memory device 34 may be any type of memory capable of storing information that can be utilized by the one or more processors 30. As such, the memory device 34 may be a solid-state memory device, magnetic memory device, optical memory device, and the like. In this example, the memory device 34 is separate from the one or more processors 30, but it should be understood that the memory device 34 may be incorporated within any of the one or more processors 30, as opposed to being a separate device.

The memory device 34 may be capable of storing one or more modules that when executed by the one or more processors 30 because the one or more processors 30 to perform any one of a number of different methods disclosed in this disclosure. In this example, the memory device 34 includes a driver list generating module 36, a driver state module 38, a deactivation module 40, and a communications module 42.

As will be explained in greater detail later in this disclosure, the driver list generating module 36, when executed by the one or more processors 30, cause the one or more processors 30 to generate a list that includes an identity and an activity state of the at least one driver. The activity state indicates that the at least one driver is one of active and inactive.

The driver state module 38, when executed by the one or more processors 30, cause the one or more processors 30 to determine that the at least one driver indicated as active on the list is inactive based on an activity factor. The deactivation module 40, when executed by the one or more processors 30, cause the one or more processors 30 to deactivate the at least one driver determined to be inactive by changing the activity state of the at least one driver to inactive.

The activity factor may be a factor that considers numerous driver behaviors including calendaring activity indicating that the at least one driver is inactive, historical activity indicating that the at least one driver routinely is inactive at a certain time, location of the vehicle, number of occupants within the vehicle, and operating state of the vehicle. With regard to calendaring information, the device 20 may include a calendar indicating the schedule of the driver. The device 20 may communicate this calendaring information to the MaaS system 12, where the MaaS system 12 will determine that the driver is scheduled to be occupied and will not be able to accept ride requests. In such a situation, the MaaS system 12 may determine that the driver should be deactivated from an active state.

Historical activity of the driver could include historical times that the driver is typically inactive. For example, the MaaS system 12, based on previous indications from the driver that the driver was either active or inactive, may determine that there is a high probability that the driver is actually inactive and should be changed from an active to inactive state. This may occur in situations where there have been times of day where the driver has been historically active and/or inactive. The MaaS system 12 may determine that if a driver has been historically inactive at a certain time of day, the MaaS system 12 may deactivate an active driver.

The location of the vehicle may also be part of the activity factor. For example, if the vehicle is located at a home location, the MaaS system 12 may determine that the driver is actually inactive and change the state of the driver from inactive to active. Other locations of the vehicle may also indicate that the driver is inactive. These other locations could include when the vehicle is parked at a grocery store, shopping mall, church, school, and the like. In addition to the location of the vehicle, the time in which the vehicle has stayed at a certain location may be considered when determining if the driver is actually inactive and not active.

The number of occupants within the vehicle may also be part of the activity factor. As stated previously, the vehicle data collection device 22 includes a number of different sensors 84, 86, and/or 88 that may be able to determine the number of occupants located within the vehicle. In a situation where there are no occupants, the MaaS system 12 may determine that the driver is not active and deactivate the driver accordingly. Additionally, in a situation where the driver has not been sent a request to pick up a passenger, but the vehicle indicates that there are multiple occupants located within the vehicle, the MaaS system 12 may assume that the driver is performing other duties unrelated to the MaaS provider and the MaaS system 12 may deactivate the driver.

The communications module 42, when executed by the one or more processors 30, cause the one or more processors 30 to transmit, via the network access device 32, a deactivation message to the device 20 of the at least one driver determined to be inactive. The deactivation message may inform the at least one driver that the at least one driver will be deactivated by the MaaS system 12.

A database 44 may be in communication with the processor 30 of the MaaS system 12. The database 44 is a storage device capable of storing information. The database 44 may be a single storage device or may be multiple storage devices that act in concert to store information. In this example, the database 44 is shown to be separate from the MaaS system 12. However, it should be understood that the database 44 may be incorporated within the MaaS system 12. Furthermore, the database 44, if incorporated within the MaaS system 12, may be incorporated within the one or more processors 30 and/or the memory device 34.

The database 44 generally stores information regarding one or more drivers. In this example, the database 44 includes the identity 46A, 46B, and 46C of the drivers 18A, 18B, and 18C of FIG. 1, respectively. In addition to identity information, the database 44 may also include indicator 48A, 48B, and 48C that indicates if the drivers 18A, 18B, and 18C of FIG. 1, respectively, are in an active or inactive state. As explained before, a driver may be considered to be in an active state when the driver is willing to respond to requests from the MaaS system 12 to pick up one or more passengers. The driver may be considered to be in an inactive state when the driver is unwilling to respond to requests from the MaaS system 12 to pick up one or more passengers. As such, drivers that have been an indicator indicating that they are inactive, will not receive requests to pick up passengers from the MaaS system 12.

The database 44 may also include additional information 50A, 50B, and 50C regarding the drivers 18A, 18B, and 18C of FIG. 1, respectively. This additional information 50A, 50B, and 50C could include information such as home address of the driver, calendaring information of the driver indicating any appointments the driver may have, behavioral information regarding the driver's driving habits, historical activity indicating whether the driver is routinely inactive at a certain time, current location of the vehicle of the driver, current location of the device 20 of the driver, number of occupants currently within the vehicle of the driver, and the operating state of the vehicle. There may be also other information regarding how quickly a driver responds to a request to pick up a passenger and/or how quickly a driver responds to a deactivation message from the MaaS system 12 that the driver is going to be deactivated.

As to the device 20, as previously stated, the device 20 may be a mobile device, such as a mobile phone, that is operated by a driver, such as drivers 18A, 18B, and/or 18C of FIG. 1. The device 20 may include one or more processors 52 in communication with a memory device 54, an input device 60, an output device 62, and a network access device 64. With regards to the memory device 54, the memory device 54 may be any type of memory device capable of storing information that can be utilized by the one or more processors 52. The memory device 54 may be separate from the one or more processors 52, as shown, or may be incorporated within the one or more processors 52.

The memory device 54 may include instructions 56 for executing any one of a number of different applications, such as application 58, located on the memory device 54. The application 58 may be an application that allows for communicating with the MaaS system 12. Here, the application 58 may allow a driver to receive requests to pick up passengers from the MaaS system 12 via the device 20. In addition, the application 58 may allow a driver to inform the MaaS system 12 whether they are active or inactive. Further, the application 58 may allow a driver to send or receive messages from the MaaS system 12 and/or send them receive information regarding the driver, such as the information previously described as stored in the database 44.

The input device 60 may be any type of device that allows the driver to provide information to the one or more processors 52 of the device 20. As such, the input device 60 may be a touchscreen and/or keyboard that allows the driver to provide information to the one or more processors 52. The type of information that may be provided from the driver via the input device 60 may include any of the information previously described as stored in the database 44. As such, this information could include driver identity information, information regarding if the driver is active or inactive, calendaring information, location of the device 20, behavioral information, historical information, and the like.

The output device 62 may be any type of device that allows the driver to receive information from the one or more processors 52 of the device 20. The information from the one or more processors 52 could be information that originated from the MaaS system 12. In one example, the output device 62 may be a display device that visually displays information to the driver. Additionally, it should be understood that the input device 60 and the output device 62 may be incorporated as a touchscreen that allows for inputting information from the driver as well as displaying information to the driver. Information displayed by the output device 62 could include a request to pick up passenger, a deactivation message from the MaaS system 12, or other information to or from the MaaS system 12.

The network access device 64 allows the one or more processors 52 of the device 20 to communicate with a network 28, such as the Internet. As such, the network access device 64 may be any one of a number of different components that allow the transmission of information to the network 28 and therefore to other electronic systems and subsystems connected to the network 28. These electronic systems and subsystems could include the MaaS system 12 and/or the vehicle data collection device 22. The network access device 64 may be connected to an antenna 66 that allows for the wireless transmission and reception of data from the device 20.

The vehicle data collection device 22 may include one or more processors 70 that may be in communication with the memory device 72, a network access device 73, a GNSS system 76, and/or one or more vehicle sensors 84, 86, and/or 88. The memory device 72 may be any type of memory device capable of storing information that can be utilized by the one or more processors 70. The memory device 72 may be incorporated with in the one or more processors 70 or may be, as shown, separate from the one or more processors 70. The memory device 72 may include instructions 74 to execute methods related to collecting information regarding the activities of the vehicle, such as vehicles 16A, 16B, and/or 16C of FIG. 1. Information collected may be stored as stored information 77 on the memory device 72.

The network access device 73, similar to the other described network access devices, may include any one of a number of different components that allow the one or more processors 70 to communicate with a network 28, such as the Internet. The network access device 73 may include antenna 75 that allows the wireless transmission and reception of data from the distributed network 28. As such, the network access device 73 places the one or more processors 70 of the vehicle data collection device 22 in communication with the MaaS system 12 and/or the device 20.

The GNSS system 76 may be a satellite navigation system that provides autonomous geo-spatial positioning with global coverage. The GNSS system 76 may include anyone of a number of different GNSS systems, such as GPS, GLONASS, Galileo, Beidou or other regional systems. The GNSS system 76 may be connected to an antenna 78 that is capable of receiving one or more signals 80 from one or more satellites 82A-82D. Based on the one or more signals 80 from one or more satellites 82A-82D, the GNSS system 76 is able to determine the relative location of the vehicle to which the GNSS system is installed. This relative location may be in the form of a coordinate system that may indicate the latitude, longitude, and/or altitude of a vehicle that has the GNSS system 76 installed within. As such, the GNSS system 76 allows for the vehicle data collection devices 22A, 22B, and 22C to determine the relative location of the vehicles 16A, 16B, and 16C of FIG. 1, respectively, and then relay this information to the MaaS system 12 and/or the device 20 via the network access device 73.

One or more vehicle sensors 84, 86, and 88 may also be in communication with the one or more processors 70. The sensors 84, 86 and/or 88 may be any one of a number of different sensors capable of sensing anyone of a number of different variables experienced by the vehicle. As such, the sensor 84 may be one or more sensor that are able to determine the number of occupants within the vehicle, including the driver and any passengers. The sensors could include pressure sensors that are located on or near the seats of a vehicle that can determine the presence of a pressure that indicates a person is seated within the seats of the vehicle. Additionally, or alternatively, the sensor 84 could be a camera system that can determine the number of occupants within the vehicle.

The sensor 86 may be a sensor that can determine the operating state of the vehicle. The sensor 86 may be able to collect information regarding if the vehicle is currently operating or is in a parked or disabled state.

The sensor 88 may be a safety-related sensor, such as an airbag deployment sensor or other safety system deployment sensor that could indicate if the vehicle has experienced an accident.

While the different types of sensors 84, 86, and 88 have been described, it should be understood that the sensors 84, 86, and 88 described are merely examples in that anyone of a number different sensors could be utilized to determine any one of a number different variables experienced by the vehicle. The information sensed by the sensors 84, 86, and/or 88 may be provided to the one or more processors 70 and then relayed to the MaaS system 12 and/or the device 20 via the network access device 73.

Now that the MaaS system 12, the device 20, and the vehicle data collection device 22 have been described, the methodology for deactivating an inactive driver will be described. Method 100 will be discussed from the perspective of the MAAS system 12 of FIGS. 1 and 2. While method 100 is discussed in combination with the MAAS system 12, it should be appreciated that the method 100 is not limited to being implemented within the Maas system 12, but is instead one example of a system that may implement the method 100. For example, all or parts of the method 100 may be performed by the device 20.

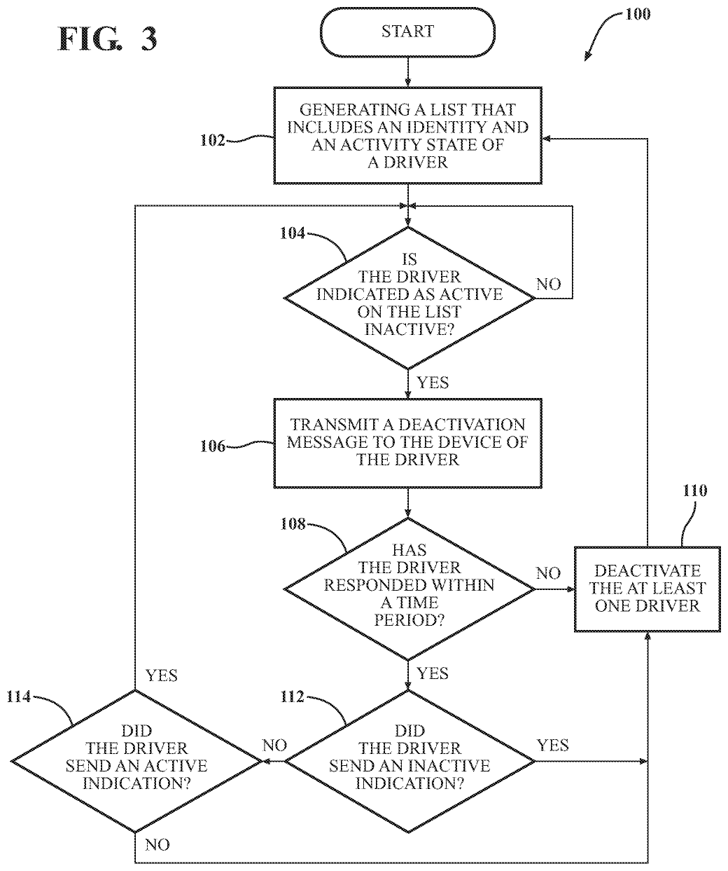

Referring to FIG. 3, a method of 100 for deactivating a driver, such as drivers 18A, 18B, and/or 18C of FIG. 1 is shown. The method 100 begins at step 102. At step 102, the method 100 generates a list that includes an identity and activity state of at least one driver. The activity state indicates whether the driver is either active or inactive. As described previously, the driver is considered active when the driver responds to ride requests from the MaaS system 12. Conversely, the driver is considered to be inactive when the driver does not respond to ride requests from the MaaS system 12.

The step 102 may be performed by the one or more processors 30 when the one or more processors 30 execute the driver list generating module 36. The list generated in step 102 may be in the form of the information stored within the database 44 of FIG. 2. As previously noted, the database 44 may include information such as the identity of one or more drivers, the activity state of the one or more drivers, and other information regarding the one or more drivers.

At step 104, a determination is made whether the driver that is indicated as active on the list is actually inactive. The step 104 may utilize an activity factor regarding the activity of the driver and/or the vehicle the driver utilizes. The step 104 may be performed by the one or more processors 30 of the MaaS system 12 when the one or more processors 30 execute the driver state module 38 of FIG. 2.

The vehicle state may also be part of the activity factor. As stated before, the vehicle data collection device 22 include sensors 84, 86, and/or 88 that may be able to determine the operating state of the vehicle and if one or more vehicle safety systems have been deployed. If these sensors indicate that the vehicle is not active, such as not being in the on position, the MaaS system 12 may determine that the driver is inactive. Furthermore, if a vehicle safety system is deployed, the MaaS system 12 may determine that the driver is inactive and/or may attempt to contact the driver or send help to the driver.

Instead of simply deactivating the driver, the MaaS system 12 may attempt to communicate with the driver by the device 20. As best shown in step 106, the method 100 transmits a deactivation message to the device 20 of the driver. This may be performed by the one or more processors 30 when executing the communications module 42. Here, the deactivation message informs the driver that the driver will be changed from an active to an inactive state by the MaaS system 12.

The deactivation of the driver by the MaaS system 12 after sending the deactivation message may be immediate or may be time-based. In step 108, the method 100 determines if the driver has responded to the deactivation message within a period of time. The driver may respond to the deactivation message by utilizing the device 20 to communicate with the MaaS system 12. The amount of time that the MaaS system 12 may wait before deactivating the driver may be a preset period of time based on a learned response of the driver to a prior deactivation message. For example, in response to prior deactivation messages, the driver has responded as being active within three minutes, the preset period of time may be set to three minutes. This preset period of time may be learned over multiple instances regarding the responsiveness of the driver to either the deactivation message and/or any other requests made by the MaaS system 12 upon the driver, such as pickup requests.

Once the period of time has expired, the method 100 continues to step 110, wherein the MaaS system 12 deactivates the driver. This may be performed by the one or more processors 30 of the MaaS system 12 when executing the deactivation module 40 of FIG. 2. After deactivation, the method 100 may end or may return to step 102 or 104.

If the driver responds to the deactivation message, the method 100 continues to step 112. At step 112, a determination is made if the driver indicated that they are either active or inactive. If the driver indicates that they are in active, the method 100 proceeds to step 110 where the MaaS system 12 deactivates the driver. Again, this may be performed by the one or more processors 30 of the MaaS system 12 when executing the deactivation module 40 of FIG. 2. After deactivation, the method 100 may end or may return to step 102 or 104.

If the driver does not send an inactive indication, the method proceeds to step 114. Here, the method 100 determines if the driver sent an active indication to the MaaS system 12. If the driver sent an active indication to the MaaS system 12, the driver is kept in an active state in the method 100 either ends and returns to either step 102 and/or step 104. Otherwise, the driver is deactivated.

It should be appreciated that any of the systems described in this specification can be configured in various arrangements with separate integrated circuits and/or chips. The circuits are connected via connection paths to provide for communicating signals between the separate circuits. Of course, while separate integrated circuits are discussed, in various embodiments, the circuits may be integrated into a common integrated circuit board. Additionally, the integrated circuits may be combined into fewer integrated circuits or divided into more integrated circuits.

In another embodiment, the described methods and/or their equivalents may be implemented with computer-executable instructions. Thus, in one embodiment, a non-transitory computer-readable medium is configured with stored computer executable instructions that when executed by a machine (e.g., processor, computer, and so on) cause the machine (and/or associated components) to perform the method.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional blocks that are not illustrated.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer readable program code embodied, e.g., stored, thereon. Any combination of one or more computer-readable media may be utilized. The computer-readable medium may be a computer readable signal medium or a computer-readable storage medium. The phrase “computer-readable storage medium” means a non-transitory storage medium. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Examples of such a computer-readable medium may include, but are not limited to, a floppy disk, a flexible disk, a hard disk, a magnetic tape, other magnetic medium, an ASIC, a graphics processing unit (GPU), a CD, other optical medium, a RAM, a ROM, a memory chip or card, a memory stick, and other media from which a computer, a processor or other electronic device can read. In the context of this document, a computer-readable storage medium may be any tangible medium that can contain or store a program for use by or in connection with an instruction execution system, apparatus, or device.

The following includes definitions of selected terms employed herein. The definitions include various examples and/or forms of components that fall within the scope of a term, and that may be used for various implementations. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Module,” as used herein, includes a computer or electrical hardware component(s), firmware, a non-transitory computer-readable medium that stores instructions, and/or combinations of these components configured to perform a function(s) or an action(s), and/or to cause a function or action from another logic, method, and/or system. Module may include a microprocessor controlled by an algorithm, a discrete logic (e.g., ASIC), an analog circuit, a digital circuit, a programmed logic device, a memory device including instructions that when executed perform an algorithm, and so on. A module, in one or more embodiments, may include one or more CMOS gates, combinations of gates, or other circuit components. Where multiple modules are described, one or more embodiments may include incorporating the multiple modules into one physical module component. Similarly, where a single module is described, one or more embodiments distribute the single module between multiple physical components.

Additionally, module, as used herein, includes routines, programs, objects, components, data structures, and so on that perform tasks or implement data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), as a graphics processing unit (GPU), or as another suitable hardware component that is embedded with a defined configuration set (e.g., instructions) for performing the disclosed functions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A Mobility-as-a-Service (“MaaS”) system for deactivating at least one driver of a vehicle, the MaaS system comprising:
one or more processors;
a memory device in communication with the one or more processors, the memory device storing:
a driver list generating module that when executed by the one or more processors cause the one or more processors to generate a list that includes an identity and an activity state of the at least one driver, wherein the activity state indicates that the at least one driver is one of active and inactive;
a driver state module that when executed by the one or more processors cause the one or more processors to determine that the at least one driver indicated as active on the list is inactive based on an activity factor; and
a deactivation module that when executed by the one or more processors cause the one or more processors to deactivate the at least one driver determined to be inactive by changing the activity state of the at least one driver to inactive.

2. The MaaS system of claim 1, wherein the at least one driver is active when the at least one driver responds via a device to at least one ride request transmitted from the MaaS system to the device, wherein the at least one driver is inactive when the at least one driver does not respond via the device to at least one ride request transmitted from the MaaS system to the device.

3. The MaaS system of claim 1, wherein the activity factor includes at least one of the following: calendaring activity indicating that the at least one driver is inactive, historical activity indicating that the at least one driver routinely is inactive at a certain time, location of the vehicle, number of occupants within the vehicle, and operating state of the vehicle.

4. The MaaS system of claim 1, further comprising:
a network access device in communication with the one or more processors, the network access device configured to transmit and receive information from at least one of a device of the at least one driver and the vehicle of the at least one driver; and
the memory device storing a communications module that when executed by the one or more processors cause the one or more processors to transmit, via the network access device, a deactivation message to the device of the at least one driver determined to be inactive, the deactivation message informing the at least one driver that the at least one driver will be deactivated by the MaaS system.

5. The MaaS system of claim 4, wherein the deactivation module further includes instructions when executed by the one or more processors cause the one or more processors to:
wait a preset period of time after transmitting the deactivation message to the device of the at least one driver to deactivate the at least one driver, and
deactivate the at least one driver determined to be inactive by changing the activity state of the at least one driver to inactive after the preset period of time expires.

6. The MaaS system of claim 5, wherein the preset period of time is based on a learned response of the at least one driver to at least one prior deactivation message.

7. The MaaS system of claim 5, wherein the communications module further includes instructions when executed by the one or more processors cause the one or more processors to receive a response message transmitted from the device of the at least one driver receiving the deactivation message, wherein the response message includes at least one of:
an inactive indication, indicating that that the at least one driver is inactive; and
an active indication, indicating that the at least one driver is active.

8. The MaaS system of claim 7, wherein the deactivation module further includes instructions when executed by the one or more processors cause the one or more processors to deactivate the at least one driver when the response message includes the inactive indication.

9. A method for deactivating at least one driver of a vehicle of a Mobility-as-a-Service (“MaaS”) system, the method comprising the steps of:
generating by a MaaS system a list that includes an identity and an activity state of the at least one driver, wherein the activity state indicates that the at least one driver is one of active and inactive;
determining, by the MaaS system, that the at least one driver indicated as active on the list is inactive based on an activity factor; and
deactivating, by the MaaS system, the at least one driver determined to be inactive by changing the activity state of the at least one driver to inactive.

10. The method of claim 9, wherein the at least one driver is active when the at least one driver responds via a device to at least one ride request transmitted from the MaaS system to the device, wherein the at least one driver is inactive when the at least one driver does not respond via the device to at least one ride request transmitted from the MaaS system to the device.

11. The method of claim 9, wherein the activity factor includes at least one of the following: calendaring activity indicating that the at least one driver is inactive, historical activity indicating that the at least one driver routinely is inactive at a certain time, location of the vehicle, number of occupants within the vehicle, and operating state of the vehicle.

12. The method of claim 9, further comprising the steps of transmitting, by the MaaS system, a deactivation message to a device of the at least one driver determined to be inactive, the deactivation message informing the at least one driver that the at least one driver will be deactivated by the MaaS system.

13. The method of claim 12, further comprising the steps of:
waiting, by the MaaS system, a preset period of time after transmitting the deactivation message to the device of the at least one driver to deactivate the at least one driver; and
deactivating, by the MaaS system, the at least one driver determined to be inactive by changing the activity state of the at least one driver to inactive after the preset period of time expires.

14. The method of claim 13, wherein the preset period of time is based on a learned response of the at least one driver to at least one prior deactivation message.

15. The method of claim 12, further comprising the step of receiving a response message from the device of the at least one driver receiving the deactivation message,
wherein the response message includes at least one of:
an inactive indication, indicating that that the at least one driver is inactive, and
an active indication, indicating that the at least one driver is active.

16. The method of claim 15, further comprising the step of deactivating, by the MaaS system, the at least one driver when the response message includes the inactive indication.

17. A non-transitory computer-readable medium for deactivating at least one driver of a vehicle, using a Mobility-as-a-Service (“MaaS”) system and including instructions that when executed by one or more processors cause the one or more processors to:
generate a list that includes an identity and an activity state of the at least one driver, wherein the activity state indicates that the at least one driver is one of active and inactive;
determine that the at least one driver indicated as active on the list is inactive based on an activity factor; and
deactivate the at least one driver determined to be inactive by changing the activity state of the at least one driver to inactive.

18. The non-transitory computer-readable medium of claim 17, wherein the at least one driver is active when the at least one driver responds via a device to at least one ride request transmitted from the MaaS system to the device, wherein the at least one driver is inactive when the at least one driver does not respond via the device to at least one ride request transmitted from the MaaS system to the device.

19. The non-transitory computer-readable medium of claim 17, wherein the activity factor includes at least one of the following: calendaring activity indicating that the at least one driver is inactive, historical activity indicating that the at least one driver routinely is inactive at a certain time, location of the vehicle, number of occupants within the vehicle, and operating state of the vehicle.

20. The non-transitory computer-readable medium of claim 17, further including instructions that when executed by one or more processors cause the one or more processors to transmit, via a network access device, a deactivation message to a device of the at least one driver determined to be inactive, the deactivation message informing the at least one driver that the at least one driver will be deactivated by the MaaS system.
